(19) United States
(12) Patent Application Publication
(10) Pub. No.: US 2012/0062749 A1
(43) Pub. Date: Mar. 15, 2012

(54) HUMAN BODY IDENTIFICATION METHOD USING RANGE IMAGE CAMERA AND HUMAN BODY IDENTIFICATION APPARATUS

(76) Inventor: Yasutaka KAWAHATA, Otsu (JP)

(21) Appl. No.: 13/226,771

(22) Filed: Sep. 7, 2011

(30) Foreign Application Priority Data
Sep. 9, 2010 (JP) 2010-201851

(51) Int. Cl. H04N 7/18

(52) U.S. Cl. 348/152; 348/E07.085

(57) ABSTRACT

A human body identification method includes a monitoring target region capturing step of obtaining a range image of a monitoring target region using a range image camera, a normal vector image calculation step of calculating a normal vector image, a template preparation step of preparing, as a template, a normal vector image from a range image captured so as to include at least a head portion of a human body, a template scaling step of scaling the size of each template based on range information that is a pixel value, a human body corresponding region estimation step of estimating at least one region corresponding to a human body, and a number-of-persons determination step of determining the number of human bodies based on a logical sum of the at least one region estimated as corresponding to a human body.

### CROSS-REFERENCE TO RELATED APPLICATION

This application claims priority under 35 U.S.C. §119(a) on Patent Application No. 2010-201851 filed in Japan on Sep. 9, 2010, the entire contents of which are herein incorporated by reference.

### BACKGROUND OF THE INVENTION

1. Field of the Invention

The present invention relates to a human body identification method using a range image camera and a human body identification apparatus that are suitable for a security apparatus, a camera system, an automatic door sensor, and the like, and in particular to a human body identification method using a range image camera and a human body identification apparatus that enable accurate detection of so-called tailgating (anti-tailgating).

2. Related Art

Conventionally, as technology for identifying an object in an image such as a human body, a method has been proposed in which, for example, utilizing the density difference between an object image and the surrounding background image in a two-dimensional image that has been converted into digital data, normal vectors of the contour portion of the object image are obtained, and the object image is identified based on the obtained normal vectors (see Japanese Patent No. 3390426, for example). This object image identification method is a method for identifying an object image utilizing a density difference between a background image and an object image in an image, the method including: dividing a screen captured by a camera into a plurality of blocks; obtaining, for one of the blocks, an insertion image in which a standard object image corresponding to the block is arranged using an arrangement point as a reference, the arrangement point being an arbitrary point in the block in an image where a background image is located; obtaining; in the insertion image, a group of standard normal vectors at a contour portion of the standard object image based on a density difference between the standard object image and the background image; obtaining vector data having position information indicating a shift from the arrangement point of the standard image object to each normal vector of the standard normal vector group and angle information of each normal vector in association with each other; storing the vector data as standard data for the standard object image in the block in which the normal vectors of the standard normal vector group were detected; executing processing from arranging the standard object image to storing standard data for all of the divided blocks; then obtaining a group of normal vectors at the contour portion of an object image based on a density difference between the object image and the background image from an input image in a screen obtained by the camera capturing an object to be recognized; obtaining a group of correct points, each corresponds to an arrangement point of the standard object image, from the normal vector group based on the standard data stored in the blocks where individual normal vectors of the normal vector group appear; and evaluating a focus point region formed by the correct point group.

There is a problem in that since a two-dimensional image used in such technology is a gray scale image that reflects the tones of target space and is thus likely to be affected by changes in the amount of external light, the technology can only be used in an environment in which there is very little change in the amount of light.

In view of this, an image processing apparatus has also been proposed that can obtain the position of a target with sufficient reproducibility even in a case in which the amount of light changes in target space (see JP 2006-145352A, for example).

This image processing apparatus includes: a light-emitting source that emits light to target space; a photodetector that captures an image of the target space; an image generation unit that obtains the distance to a target based on the output of the photodetector corresponding to light emitted to the target space from the light-emitting source and reflected by the target in the target space, and generates a range image in which a pixel value is a range value; a differential processing unit that obtains a gradient direction value indicating the gradient direction of each pixel relative to a reference plane set in the target space from the range value of the range image, and generates a gradient direction image in which the gradient direction value is a pixel value; a template storage unit that, using, as a template image, the gradient direction image generated from the range image of the target to be used as a template, stores the distance between a reference point set in the template image and each pixel included in the template image, an angle formed by the direction that connects the reference point and the pixel relative to a reference direction of the template image, and the gradient direction value of the pixel in association with each other; a reference point candidate calculation unit that calculates a candidate in the detection target image for the coordinate position corresponding to the reference point in the template image by applying a distance and an angle obtained for each pixel of a detection target image by referring to the template storage unit based on the gradient direction value to the coordinate position of the pixel, the detection target image being the gradient direction image generated from the range image including the target to be detected; a statistic processing unit that obtains the frequency distribution of candidates for the coordinate positions obtained for the pixels by the reference point candidate calculation unit; and a determination processing unit that determines that a coordinate position that satisfies predetermined conditions among the coordinate positions whose frequency is the greatest in the frequency distribution obtained by the statistic processing unit is a coordinate position corresponding to the reference point in the template image.

As technology similar to this, an image processing apparatus has also been proposed that detects a target by generating, from a range image, a range differential image in which a range differential value is a pixel value, instead of generating a gradient direction image in which a gradient direction value obtained from a range image is a pixel value (see JP 2006-053792A, for example).

With conventional technology as described above, so-called tailgating cannot always be accurately detected, and there has been a problem that, for example, a big person or a person with baggage is incorrectly detected as two persons, or two small persons such as children are incorrectly detected as one person.

### SUMMARY OF THE INVENTION

The present invention provides a human body identification method using a range image camera and a human body identification apparatus that enable detection of tailgating as accurately as possible, and for example, that allow a single person to pass through without stopping him/her even in a case where he/she has baggage, and also enable recognition and prevention of two persons extremely close to each other trying to pass through.

A human body identification method using a range image camera of the present invention is a human body identification method using a range image camera, the method including: a monitoring target region capturing step of obtaining, using the range image camera installed above a monitoring target region or on periphery thereof, a monitoring target region range image that is a range image of the monitoring target region; a normal vector image calculation step of calculating a normal vector of each portion from the monitoring target region range image obtained in the monitoring target region capturing step, and calculating a monitoring target region normal vector image that is a normal vector image in which a direction of each of the calculated normal vectors is a pixel value; a template preparation step of respectively calculating a normal vector of each portion from at least one range image captured so as to include at least a head portion of a human body or at least one range image obtained by calculation based on a condition in which at least a head portion of a three-dimensional human body model is included, and respectively preparing, as a template, a human body normal vector image that is a normal vector image in which a direction of each of the calculated normal vectors is a pixel value; a template scaling step of, based on range information that is a pixel value of the monitoring target region range image, relatively scaling each size of the templates prepared in the template preparation step with respect to the monitoring target region normal vector image; a human body corresponding region estimation step of estimating at least one region corresponding to a human body in the monitoring target region normal vector image, based on a result of comparison between a predetermined threshold value and a degree of matching between each of the templates scaled in the template scaling step and the monitoring target region normal vector image; and a number-of-persons determination step of determining the number of human bodies based on a logical sum of the at least one region estimated as corresponding to a human body in the human body corresponding region estimation step.

According to the human body identification method using the range image camera and having such a configuration, tailgating can be detected as accurately as possible, and thus, for example, even in a case where a single person has baggage, the person is allowed to pass through without being stopped, and in a case where two persons extremely close to each other are trying to pass through, that can be recognized and prevented. Thus, the reliability of human body identification can be increased.

Further, the human body identification method using the range image camera of the present invention may further include a template deformation step of deforming each shape of the templates prepared in the template preparation step based on the range information that is a pixel value of the monitoring target region range image and pixel position information. Moreover, the predetermined threshold value used in the human body corresponding region estimation step may be changed based on the range information that is a pixel value of the monitoring target region range image.

According to the human body identification method using the range image camera and having such a configuration, even if the size and shape of an image to be detected such as a human body change depending on the distance to the range image camera and the position in an image, a situation in which a human body cannot be accurately detected due to the influence thereof can be avoided as much as possible. Accordingly, the reliability of human body identification can be further increased.

In the human body identification method using the range image camera of the present invention, at least a head portion and a shoulder portion may be included in capturing of an image of a human body when preparing a template in the template preparation step.

According to the human body identification method using the range image camera and having such a configuration, further accurate human body detection will be possible, compared with the case where only a head portion of a human body is used. Accordingly, the reliability of human body identification can be further increased.

In the human body identification method using the range image camera of the present invention, a template to be applied in the human body corresponding region estimation step may be decided based on information that indicates a height at which the range image camera is installed and that has been input from outside. Alternatively, from the monitoring target region range image obtained in the monitoring target region capturing step, a plane corresponding to a floor surface or ground may be recognized and a height at which the range image camera is installed may be calculated, and a template to be applied in the human body corresponding region estimation step may be decided based on information on the plane and the height.

According to the human body identification method using the range image camera and having such a configuration, based on the information indicating the height at which the range image camera is installed and the range information indicating a pixel value of the monitoring target region range image, it is possible to acquire a height of a human body, and select a more appropriate template. Accordingly, the reliability of human body identification is further improved.

Alternatively, a human body identification apparatus of the present invention includes an imaging element capable of obtaining range information for a pixel value, and generating a range image; and an image processing unit that performs image processing on the range image, wherein any human body identification method that uses the range image camera and that has been described above is executed in the image processing by the image processing unit.

According to the human body identification apparatus having such a configuration, tailgating can be detected as accurately as possible, and thus, for example, even in a case where a single person has baggage, the person is allowed to pass through without being stopped, and in a case where two persons extremely close to each other are trying to pass through, that can be recognized and prevented. Thus, the reliability of human body identification can be increased.

According to the human body identification method using the range image camera and the human body identification apparatus of the present invention, tailgating can be detected as accurately as possible, and thus, for example, even in a case where a single person has baggage, the person is allowed to pass through without being stopped, and in a case where two persons extremely close to each other are trying to pass through, that can be recognized and prevented. Thus, the reliability of human body identification can be increased.

### BRIEF DESCRIPTION OF THE DRAWINGS

FIG. 1 is a block diagram showing a schematic configuration of a range image camera 10 according to one embodiment of the present invention.

FIG. 2A is an explanatory diagram in a case where two persons H1 and H2 are in a so-called tailgating state, and FIG. 2B shows an example of an image captured by the range image camera 10 at that time.

FIG. 3A is an explanatory diagram in a case where two persons H1 and H3 are in a tailgating state, with the person H3 being smaller in height, and FIG. 3B shows an example of an image captured by the range image camera 10 at that time.

FIG. 4A is an explanatory diagram in a case where, unlike the case in FIG. 2A, the two persons H1 and H2 are slightly separated from each other, and FIG. 4B shows an example of an image captured by the range image camera 10 at that time.

FIG. 5A is an explanatory diagram in a case where there is only one tall person H4, and FIG. 5B shows an example of an image captured by the range image camera 10 at that time.

FIG. 6A is an explanatory diagram illustrating normal vector image calculation for use in template matching, and FIG. 6B is a schematic diagram in which a person H corresponding to a human body image h and the like of the range image in the case of FIG. 6A are shown in actual space.

FIG. 7 is a schematic explanatory diagram illustrating a specific example of a normal vector image calculation method.

FIG. 8 is a schematic explanatory diagram illustrating another specific example of a normal vector image calculation method.

FIG. 9 is a schematic explanatory diagram illustrating yet another specific example of a normal vector image calculation method.

FIG. 10A is an explanatory diagram illustrating a height H of the installation position at which the range image camera 10 is installed, and

FIG. 10B is an explanatory diagram illustrating a relation between human body images and the floor surface in an image captured by the range image camera 10.

FIG. 11 is an explanatory diagram illustrating template matching.

### DESCRIPTION OF PREFERRED EMBODIMENTS

Below is a description of embodiments of the present invention with reference to the drawings.

### Schematic Configuration of Range Image Camera 10 and Other Matters

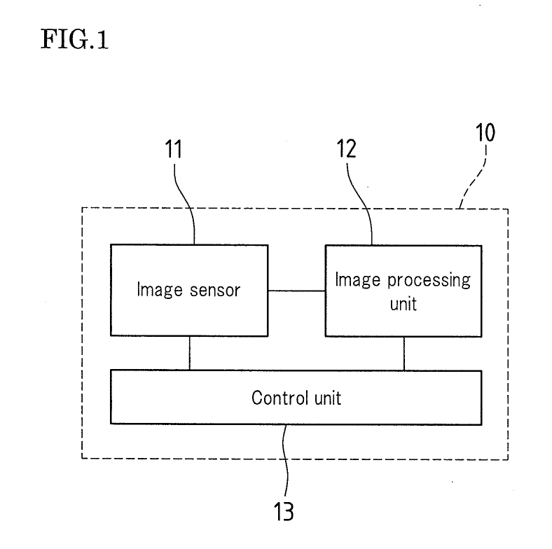

FIG. 1 is a block diagram showing a schematic configuration of a range image camera 10 according to an embodiment of the present invention. Note that this range image camera 10 also functions as a human body identification apparatus that accurately counts the number of persons passing through a monitoring target region.

As shown in FIG. 1, the range image camera 10 is provided with an image sensor 11 (for example, TOF sensor) capable of obtaining range data for pixel values based on a time period until light emitted to target space is reflected and returns and generating a range image, an image processing unit 12 that identifies a human body based on the range image (which will be described in detail below), and a control unit 13 (for example, CPU) that performs overall control of the range image camera 10 and the like.

More specifically, the image sensor 11 obtains range information for each of the pixels arranged in a square lattice. Here, assuming that X represents the horizontal direction, and Y represents the vertical direction, the range information is stored in a two-dimensional array (X, Y) corresponding to the angle of view including an object, as three-dimensional data PXY=(xXY, yXY, zXY) using the position of the range image camera 10 or an arbitrarily set origin as a reference.

The range image camera 10 is installed above a monitoring target region such as in front of an automatic door or the entrance to a room or zone in which confidential information and the like are handled, for example, and obtains a range image by capturing an image of this monitoring target region in a substantially straight downward direction from that above position.

### Examples of Images Captured in Various Situations

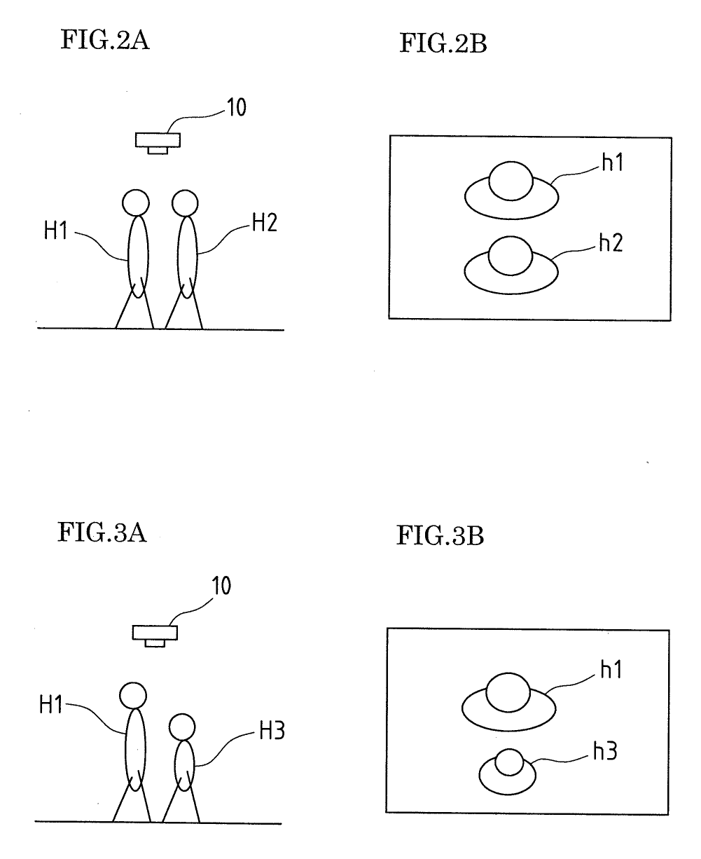

FIG. 2A is an explanatory diagram in a case where two persons H1 and H2 are in a so-called tailgating state, and FIG. 2B shows an example of an image captured by the range image camera 10 at that time. As shown in FIG. 2A, the two persons H1 and H2 are standing with a narrow space therebetween so as to sandwich the direction straight ahead of the range image camera 10. As an image captured by the range image camera 10, for example, an image is expected to be obtained in which a human body image hl corresponding to the person H1 exists at a position slightly closer to the top relative to the center, and a human body image h2 corresponding to the person H2 exists at a position slightly closer to the bottom relative to the center, as shown in FIG. 2B. At this time, the size of the human body image hl and the size of the human body image h2 are substantially the same, and the distance in the depth direction from the range image camera 10 to each of the human body images is also substantially the same.

FIG. 3A is an explanatory diagram in a case where two persons H1 and H13 are in a tailgating state, with the person H3 being smaller in height, and FIG. 3B shows an example of an image captured by the range image camera 10 at that time.

As shown in FIG. 3A, the two persons H1 and H3 are standing with a narrow space therebetween so as to sandwich the direction straight ahead of the range image camera 10. The positions at which the persons H1 and H3 are standing are respectively substantially the same as the positions at which the persons H1 and H2 are standing in FIG. 2A. However, because the person H3 is smaller in height, in an image captured by the range image camera 10, as shown in FIG. 3B for example, a human body image h3 corresponding to the person H3 appears smaller than the human body image h2 shown in FIG. 2B although the human body image h1 corresponding to the person H1 exists at a position slightly closer to the top relative to the center and the human body image h3 exists at a position slightly closer to the bottom relative to the center as in FIG. 2B. The distance in the depth direction from the range image camera 10 to the human body image h3 is longer (farther) than the distance in the depth direction from the range image camera 10 to the human body image h1.

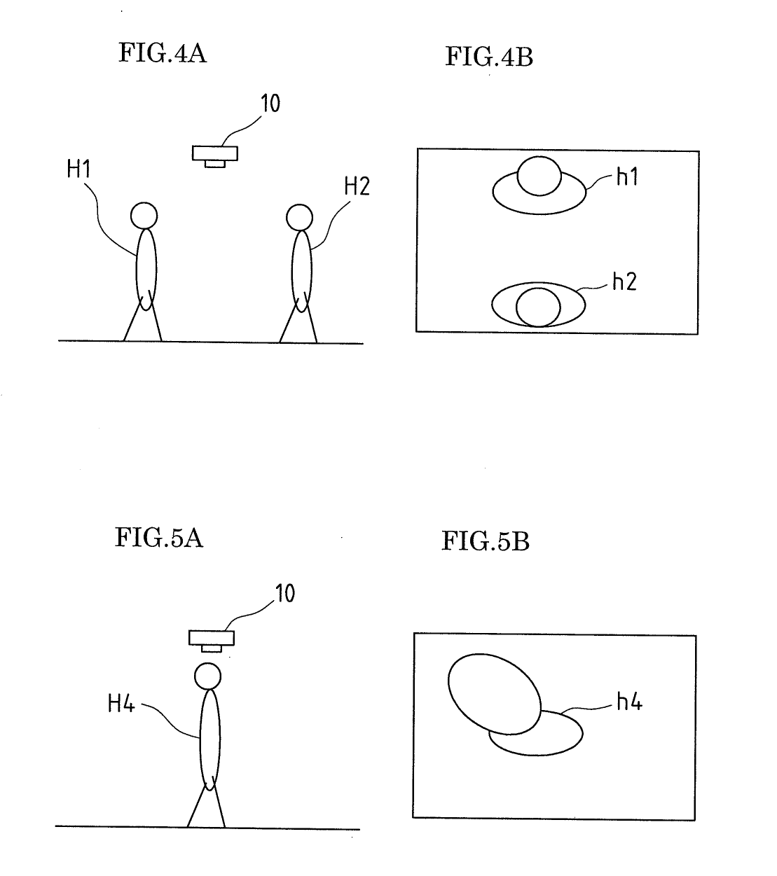

FIG. 4A is an explanatory diagram in a case where, unlike the case in FIG. 2A, the two persons H1 and H2 are slightly separated from each other, and FIG. 4B shows an example of an image captured by the range image camera 10 at that time.

As shown in FIG. 4A, the two persons H1 and H2 are standing with a wider space therebetween than that in FIG. 2A so as to sandwich the direction straight ahead of the range image camera 10. As an image captured by the range image camera 10, for example, an image is expected to be obtained in which the human body image h1 corresponding to the person H1 exists at a position considerably closer to the top relative to the center, and the human body image h2 corresponding to the person H2 exists at a position considerably closer to the bottom relative to the center, as shown in FIG. 4B. At this time, the size of the human body image h1 and that of the human body image h2 are substantially the same, and respective corresponding distances in the depth direction from the range image camera 10 also substantially the same.

FIG. 5A is an explanatory diagram in a case where there is only one tall person H4, and FIG. 5B shows an example of an image captured by the range image camera 10 at that time.

As shown in FIG. 5A, in a case where one tall person H4 is standing in the direction straight ahead of (substantially directly underneath) the range image camera 10, the distance between this person H4 and the range image camera 10 is quite short. Accordingly, as an image captured by the range image camera 10, as shown in FIG. 5B for example, although only a human body image h4 corresponding to the person H4 exists, the image appears larger than the human body image h1 in FIG. 2B as a whole, and particularly the head portion thereof appears remarkably large, and also distortion and the like will occur.

Calculation of Normal Vector Image from Range Image

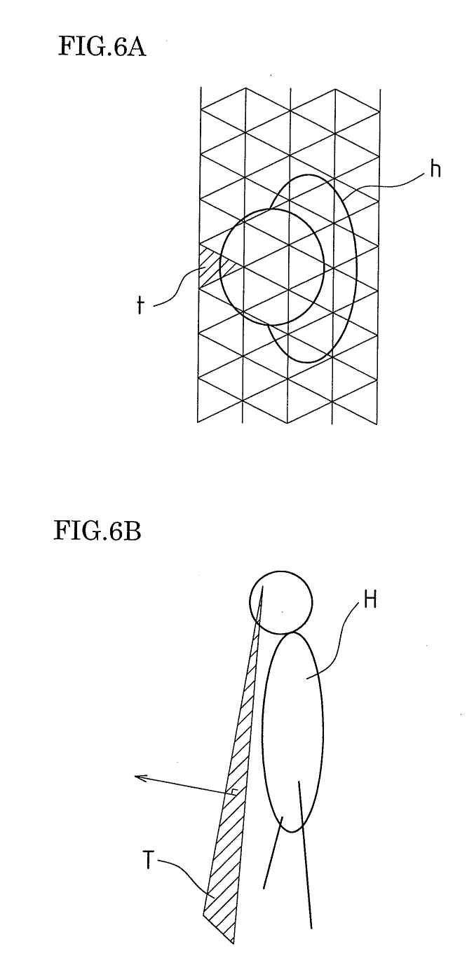

FIG. 6A is an explanatory diagram illustrating normal vector image calculation to be used for template matching, and FIG. 6B is a schematic diagram in which a person H corresponding to a human body image h and the like of the range image in the case of FIG. 6A are shown in actual space.

As shown in FIG. 6A, for example, in a case where the human body image h exists in an image captured by the range image camera 10, a normal vector of each portion is obtained based on range data of each of the pixels in the range image, and the direction and magnitude thereof are calculated. If a person H and a triangle T respectively corresponding to the human body image h and a triangle t formed by three pixels for obtaining a normal vector in the above image are schematically shown in actual space, the result will be as shown in FIG. 6B.

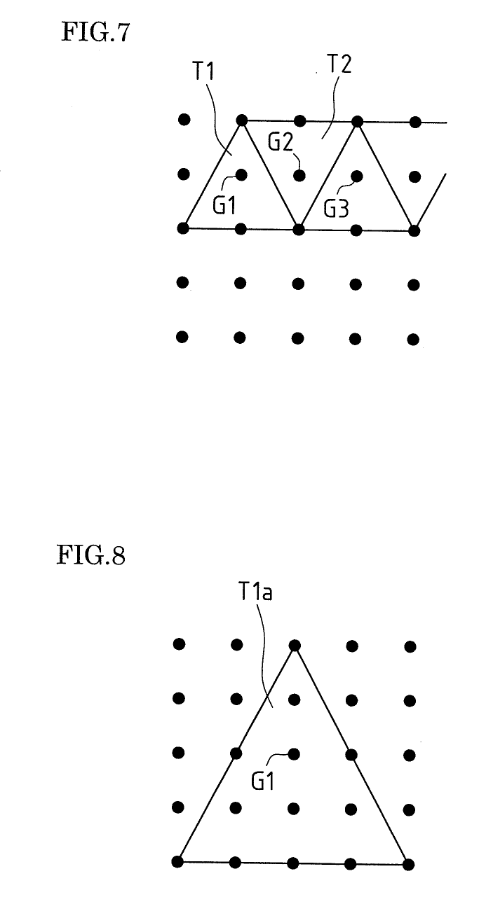

FIG. 7 is a schematic explanatory diagram illustrating a specific example of a normal vector image calculation method.

As shown in FIG. 7, for example, when a pixel G1 in a range image is focused on, an equation of a plane including a small triangle T1 surrounding the pixel G1 is calculated using range data pieces of three pixels corresponding to the vertices of the small triangle T1. The magnitude of a normal vector of the plane is normalized, and thereafter the resultant data is stored as normal vector image data (3D) corresponding to the pixel G1.

Next, a pixel G2 on the right of the pixel G1 in the range image is focused on, and using range data pieces of three pixels corresponding to the vertices of a small triangle T2 (having an upside down shape of the small triangle T1) surrounding the pixel G2, an equation of a plane including this small triangle T2 is calculated. The magnitude of a normal vector of the plane is normalized, and thereafter the resultant data is stored as normal vector image data corresponding to the pixel G2.

Moreover, a pixel G3 on the right of the pixel G2 in the range image is focused on, and the same processing is performed. After that, the same processing is repeated with respect to the remaining pixels.

FIG. 8 is a schematic explanatory diagram illustrating another specific example of a normal vector image calculation method.

As shown in FIG. 8, for example, when the pixel G1 in the range image is focused on, an equation of a plane may be calculated using range data pieces of three pixels corresponding to the vertices of a large triangle T1a surrounding the pixel G1. Here, the area of this large triangle T1a is four times larger than the area of the small triangle T1 in FIG. 7.

In this way, by changing the size of a triangle surrounding the pixel that is focused on when obtaining a normal vector, a step of enlarging/reducing an image can be omitted in the human body identification method described later.

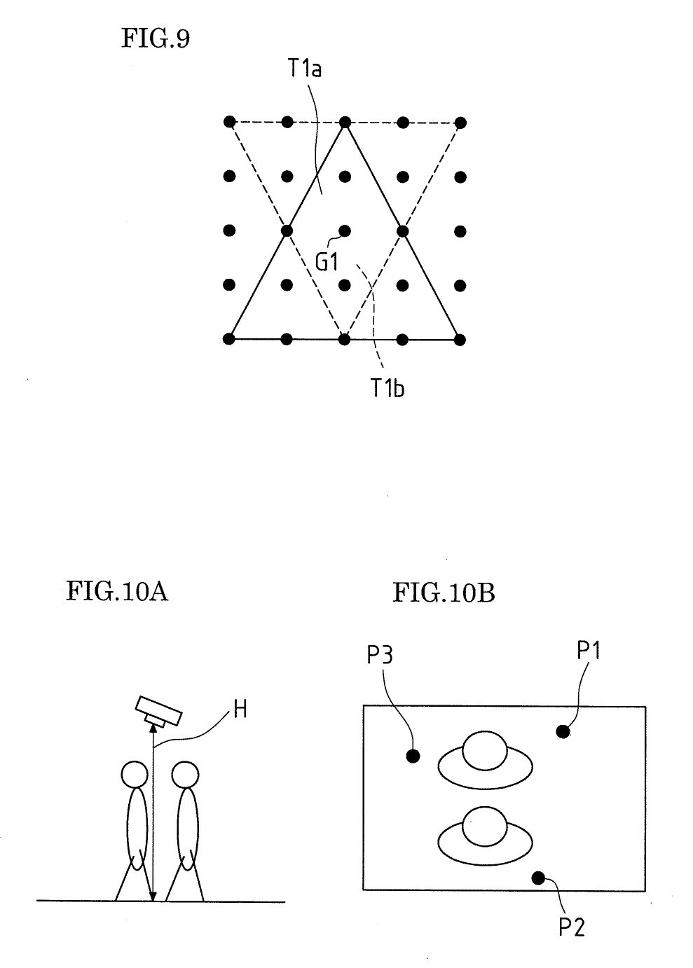

FIG. 9 is a schematic explanatory diagram illustrating yet another specific example of a normal vector image calculation method.

As shown in FIG. 9, for example, when the pixel G1 in the range image is focused on, an equation of a plane is calculated using range data pieces of three pixels corresponding to the vertices of the large triangle T1a surrounding the pixel G1, and thereafter a normal vector of that plane is obtained. Moreover, in the same manner, an equation of a plane is calculated using range data pieces of three pixels corresponding to the vertices of a large triangle T1b surrounding the pixel G1 and having an upside down shape of the large triangle T1a, and thereafter a normal vector of that plane is also obtained.

If the difference between these two normal vectors is small (which can be determined, for example, based on whether or not the inner product of these normal vectors is equal to or greater than a predetermined threshold value), the vectors have high reliability in the image as well, and thus only the portions corresponding to such pixels may be used for matching in the human body identification method that will be described below.

When obtaining such a normal vector, the arc tangent function is used in conventional technology (for example, see the expression in paragraph 0062 in the specification of JP 2006-145352A referred to in the Related Art section). Since the calculation of this function is quite complicated, it is slightly difficult to implement the function in the control unit 13 provided in the range image camera 10. In contrast, as described above, using three-dimensional data obtained by the image sensor 11, a normal vector can be obtained by a simple calculation such as a calculation of an outer product of two vectors that constitute a triangle. Further, normal vectors in accordance with the actual shape of a human body or the like can be obtained, and thus the correction of nonlinearity required in conventional technology (for example, see paragraph 0063 in the specification of JP 2006-145352A described above) and the like are also unnecessary.

### Human Body Identification Method

In the present embodiment, human bodies are accurately identified and the number thereof is counted as follows. Prior thereto, it is necessary to prepare in advance, as templates, normal vector images calculated from range images obtained by capturing the head portion of various human bodies. Note that such templates are not limited to be calculated from range images obtained by actually capturing the head portion of human bodies. For example, using three-dimensional human body models or the like obtained by modeling using, for instance, three-dimensional CAD, templates may be prepared from range images obtained by calculation based on a condition where the head portion of the models is included.

### (1) Image Capturing by Range Image Camera 10

The range image camera 10 installed above a monitoring target region captures an image of this monitoring target region in a substantially straight downward direction, thereby obtaining a range image.

(2) Calculation of Normal Vector Image from Range Image of Monitoring Target Region

From the range image obtained in (1) above, a normal vector image is calculated using the method described above.

### (3) Relative Scaling of Templates and Other Matters

First, if any object has been captured in the range image obtained in (1) above, scaling processing is performed on templates prepared in advance based on range data of pixels corresponding to the object. This is because of the following reason.

This is because the size of the head portion in an image also changes depending on the distance between the head portion of a human body and the range image camera 10 as described above with reference to FIGS. 2A to 5B, and in such a case, even if matching with a template prepared in advance is performed, an insufficiently matching result may be obtained. The size of an image may be changed instead of scaling a template, or scaling of a template and changing of the size of an image may be both performed. In other words, it is sufficient to relatively scale the size of a template with respect to the size of an image.

If a plurality of objects are captured in a range image, a plurality of template scaling processing will be performed based on range data of pixels corresponding to the respective objects.

Moreover, as described above with reference to FIGS. 5A and 5B, considering the fact that the shape of an image of the head portion of a human body is distorted if the distance to the head portion is short, the shape of a template may also be deformed accordingly. Further, the degree of distortion of the shape of a head portion image is also different in the center portion and the peripheral portion of an image, and thus the degree of deformation of the shape of a template may be changed depending on the position in the image.

Note that a configuration may be adopted in which an installation height H at which the range image camera 10 is installed as shown in FIG. 10A can be input and set by external operation, for example, when the range image camera 10 is installed or the like. The range image camera 10 is installed above the monitoring target region and is facing substantially straight downward, and thus the difference between the installation height H and the smallest value of range data of pixels corresponding to a human body captured in the range image substantially corresponds to the height of that person. Based on such information, it may be decided which template is to be applied from among templates described above, or the range in which the size and shape of the template are changed may be decided.

Further, as shown in FIG. 10B, in the image captured by the range image camera 10, the installation height H at which the range image camera 10 is installed can also be calculated if it is estimated, based on range data of pixels corresponding to, for example, appropriate three points P1, P2, and P3 in the peripheral portion, that the plane defined by these three points is a floor surface. In this case as well, based on such information, it may be decided which template is to be applied from among templates described above, or the range in which the size and shape of the template are changed may be decided.

### (4) Template Matching

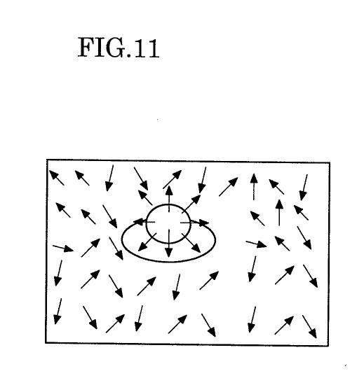

As shown in FIG. 11, matching between each template that has been scaled in (3) above and the normal vector image calculated in (2) above is performed. In order to acquire the degree of matching thereof, for example, a region in which a vectorial angular difference between a template and the normal vector image is equal to or smaller than a predetermined threshold value is searched for in the normal vector image, and it is estimated that the region corresponds to the head portion of a human body. Furthermore, this processing is repeated as necessary.

Note that for calculation of the angular difference, the magnitude of vectors before normalization is performed thereon may be used as the weight. By using the magnitude of a vector as the weight, it is possible to eliminate information different from the essence of an object that is to be detected, such as a hairstyle or a crease in clothing. Further, the predetermined threshold value may be set such that the shorter the distance is, the larger the predetermined threshold value is. This is because in the case where the distance is short, an image of the head portion may be distorted or easily affected by the person's hairstyle, posture, and the like, which may increase the difference, and thus matching can be performed in consideration of these.

### (5) Determination of Number of Human Bodies

If a plurality of regions each estimated as corresponding to the head portion of a human body exist in (4) above, the number of regions that exist after calculating the logical sum thereof is counted. The number of such regions will be the number of human bodies.

### Variations and Other Matters

A portion prepared as a template does not need to be limited only to the head portion of a human body. For example, templates including not only a head portion but also a shoulder portion are prepared, and then matching with a normal vector image of a monitoring target region is performed, thereby enabling a further improvement in the precision of human body identification.

Further, a detection target is not limited to a human body. If appropriate templates are prepared in accordance with a detection target, the present invention is also applicable to other objects and purposes.

Note that the present invention may be embodied in various other forms without departing from the gist or essential characteristics thereof. Therefore, the embodiments disclosed herein are to be considered in all respects as illustrative and not limiting. The scope of the invention is indicated by the appended claims rather than by the foregoing description. All variations and modifications that come within the equivalency range of the claims are intended to be embraced therein.

1. A human body identification method using a range image camera, the method comprising:
a monitoring target region capturing step of obtaining, using the range image camera installed above a monitoring target region or on periphery thereof, a monitoring target region range image that is a range image of the monitoring target region;
a normal vector image calculation step of calculating a normal vector of each portion from the monitoring target region range image obtained in the monitoring target region capturing step, and calculating a monitoring target region normal vector image that is a normal vector image in which a direction of each of the calculated normal vectors is a pixel value;
a template preparation step of respectively calculating a normal vector of each portion from at least one range image captured so as to include at least a head portion of a human body or at least one range image obtained by calculation based on a condition in which at least a head portion of a three-dimensional human body model is included, and respectively preparing, as a template, a human body normal vector image that is a normal vector image in which a direction of each of the calculated normal vectors is a pixel value;
a template scaling step of, based on range information that is a pixel value of the monitoring target region range image, relatively scaling each size of the templates prepared in the template preparation step with respect to the monitoring target region normal vector image;
a human body corresponding region estimation step of estimating at least one region corresponding to a human body in the monitoring target region normal vector image, based on a result of comparison between a predetermined threshold value and a degree of matching between each of the templates scaled in the template scaling step and the monitoring target region normal vector image; and
a number-of-persons determination step of determining the number of human bodies based on a logical sum of the at least one region estimated as corresponding to a human body in the human body corresponding region estimation step.

2. The human body identification method using the range image camera according to claim 1, further comprising:
a template deformation step of deforming each shape of the templates prepared in the template preparation step based on the range information that is a pixel value of the monitoring target region range image and pixel position information.

3. The human body identification method using the range image camera according to claim 1,
wherein the predetermined threshold value used in the human body corresponding region estimation step is changed based on the range information that is a pixel value of the monitoring target region range image.

4. The human body identification method using the range image camera according to claim 1,
wherein at least a head portion and a shoulder portion are included in capturing of an image of a human body when preparing a template in the template preparation step.

5. The human body identification method using the range image camera according to claim 1,
wherein a template to be applied in the human body corresponding region estimation step is decided based on information that indicates a height at which the range image camera is installed and that has been input from outside.

6. The human body identification method using the range image camera according to claim 1,
wherein from the monitoring target region range image obtained in the monitoring target region capturing step, a plane corresponding to a floor surface or ground is recognized and a height at which the range image camera is installed is calculated, and a template to be applied in the human body corresponding region estimation step is decided based on information on the plane and the height.

7. A human body identification apparatus comprising:
an imaging element capable of obtaining range information for a pixel value, and generating a range image; and
an image processing unit that performs image processing on the range image,
wherein the human body identification method according to claim 1 is executed in the image processing by the image processing unit.

8. A human body identification apparatus comprising:
an imaging element capable of obtaining range information for a pixel value, and generating a range image; and
an image processing unit that performs image processing on the range image,
wherein the human body identification method according to claim 2 is executed in the image processing by the image processing unit.

9. A human body identification apparatus comprising:
an imaging element capable of obtaining range information for a pixel value, and generating a range image; and
an image processing unit that performs image processing on the range image,
wherein the human body identification method according to claim 3 is executed in the image processing by the image processing unit.

10. A human body identification apparatus comprising:
an imaging element capable of obtaining range information for a pixel value, and generating a range image; and
an image processing unit that performs image processing on the range image,
wherein the human body identification method according to claim 4 is executed in the image processing by the image processing unit.

11. A human body identification apparatus comprising:
an imaging element capable of obtaining range information for a pixel value, and generating a range image; and
an image processing unit that performs image processing on the range image,
wherein the human body identification method according to claim 5 is executed in the image processing by the image processing unit.

12. A human body identification apparatus comprising:
an imaging element capable of obtaining range information for a pixel value, and generating a range image; and
an image processing unit that performs image processing on the range image,
wherein the human body identification method according to claim 6 is executed in the image processing by the image processing unit.
